(19) United States
(12) Patent Application Publication
(10) Pub. No.: US 2009/0223903 A1
(43) Pub. Date: Sep. 10, 2009

(54) METHODS AND APPARATUSES FOR CONTROLLING CONDITIONS IN WATER

(76) Inventors: Richard T. Coffey, Fort Lauderdale, FL (US); Kenneth Jenke, Newbury Park, CA (US); Robert Harnden, Tamarac, FL (US); Matthew R. Hodges, Boca Raton, FL (US); Luis Fernando DelCorral, Doral, FL (US)

Correspondence Address: MCDERMOTT WILL & EMERY LLP, 18191 VON KARMAN AVE., SUITE 500, IRVINE, CA, 92612-7108, US

(21) Appl. No.: 12/237,674

(22) Filed: Sep. 25, 2008

Related U.S. Application Data
(60) Provisional application No. 60/975,626, filed on Sep. 27, 2007.
(60) Provisional application No. 60/976,496, filed on Oct. 1, 2007.

(51) Int. Cl. C02F 1/50; C02F 1/76; A01N 55/02; A01P 13/00

(52) U.S. Cl. 210/754; 210/749; 210/753; 504/152

(57) ABSTRACT

The invention relates to the control of pH in water, preferably pool/spa water along with the control and/or removal of algal populations, by adding to the water a desired synergistic amount of a lanthanide-containing compound, a transition metal salt ions sufficient to bind with hydroxyl into a slightly soluble or insoluble reaction product, thereby removing sufficient hydroxyl ion from the water to lower the pH thereof, and copper and/or silver to act as an algicide and potential pH affecting compound.

### CROSS REFERENCE TO RELATED APPLICATIONS

This application claims the benefit of U.S. Provisional Application No. 60/975,626 filed on Sep. 27, 2007 and U.S. Provisional Application No. 60/976,496 filed on Oct. 1, 2007, the contents of both of which are incorporated herein by reference.

### FIELD OF THE INVENTION

The present invention relates to methods of treating water and maintaining water quality by the addition of metal ions, preferably certain rare earth and transition metal ions, most typically added as salts. More particularly, the present invention relates to the use of preferred transition metals, preferably in salt form, alone and/or in particular combination with one or more rare earth metals to achieve and help maintain desired characteristics in water, preferably contained bodies of recirculated water, such as pool and spa water.

### BACKGROUND

Purification of water, in particular of pool and spa water, is typically carried out by one or more of several different methods. Chemical methods typically involve adding chemical microbiocides, such as hypochlorite ion, silver ion, copper ion, and the like, to the water. The addition is either direct, as in most hypochlorite additions, or indirect, as in the addition of silver ion from an immobilized media, such as NATURE2®, available from Zodiac Pool Care.

However, electrochemical methods may be used in place of, or in addition to, chemical methods, as described in U.S. Pat. No. 6,761,827, the entire contents of which are incorporated herein by reference. In these methods, water having some concentration of halide ion in it (achieved by dissolution of quantities of sodium chloride, sodium bromide, or other halide salts into the water) is passed through an electrolytic cell. The halide ions are oxidized by electrolysis to form hypohalous acid, hypohalite ions, or both (believed to occur through the intermediate of molecular halogen), which have known utility in disinfecting water (and whose use is typically known as “chlorinating,” brominating, or otherwise halogenating the water). In addition, the electrolysis reaction converts water into hydrogen and hydroxyl ions and, potentially, other species.

Electrolytic purification is desirable because it is safe, effective, and for applications such as swimming pools, hot tubs, spas, etc., it eliminates much of the need for the pool owner or operator to handle chemicals and monitor water chemistry. The salinity levels necessary to achieve effective chlorination levels are typically well below the organoleptic thresholds in humans, and the primary chemical required to be handled by the operator is a simple alkali metal halide salt. In addition, operation of the electrolytic cell is comparatively easy, and requires little attention beyond ensuring that the proper current and voltage levels are set, and maintaining the correct salinity levels in the water. A further description of such purification methods is presented in co-pending and commonly owned U.S. patent applications Ser. Nos. U.S. patent application Ser. No. 11/597,148, filed Nov. 21, 2006; and Ser. No. 11/182,110, filed Jul. 15, 2005, the entire contents of which are incorporated by reference herein as if made a part of the present application.

Methods for pool and spa water purification have also focused on the cause for water impurity. Microbe and algae manifestation represent such impurities which must be removed from water, or held to acceptably low levels for the pool and/spa water to be useful for recreational purposes. Algal growth leads to undesirable coatings on the pool/spa walls and then to a discoloration of the water. The algae itself may become a nutrient for aquatic life forms, some of which may be pathenogenic for humans. Algae on surfaces may also become a physical hazard to humans by raising the risks of slipping or falling.

Many known chemical and mechanical methods for algae removal and control are known. However many algaecides are themselves harmful or unpleasant to swimmers and bathers. Rather than treating and decreasing large algal populations with toxic approaches, it has been contemplated to remove the nutrient source for the algae from the pool/spa water.

For example, it is known that phosphate levels are directly proportional to levels of algae and other unwanted biotics in pool and spa water. It is believed and generally accepted that the three primary food sources necessary to support unwanted algae growth in water are nitrates, carbon and phosphates. Phosphates enter pool and spa systems from sources such as runoff, leaves, bark, pool chemicals, cleaners, soaps, bathers, source water, etc. These sources proceed to orthophosphates which are digestible by algae, leading to potentially prolific algal growth in pool and spa water, or even larger bodies of natural water.

For example, the presence of excess phosphate in naturally occurring waters can lead to their deterioration via eutrophication. In this destructive process, algae and other microorganisms reproduce at an accelerated rate and consume oxygen in the water, making the water uninhabitable for higher life forms such as fish and amphibians. As a result, phosphates have been banned from various consumer products, such as laundry detergents throughout the U.S. and Europe, since the 1970's.

While lanthanum or zinc, separately, have been known to react with phosphates in arenas other than the pool/spa environment, the use of optimum easy-to-handle, dose-friendly and stable lanthanum or zinc compounds as aids in phosphate removal from pool/spa environments has not been satisfactorily accomplished.

More specifically, it is known to use soluble salts of Al, La, Zr and Ti to precipitate phosphate from open bodies of water such as, for example, lakes. Use of rare earth salts, such as La₂(CO₃)₃ added as a liquid have been known to precipitate phosphate from pool water in a fine suspension that can be removed using conventional flocculants. However, the sub-micron particles pass through most pool filters and require unacceptably large amounts of flocculants resulting in repeated filter blockage.

Similarly, use of lanthanum carbonate La₂(CO₃)₃ and lanthanum oxide La₂O₃ as aids to effect phosphate precipitation and act as phosphate scavengers is also known. However, these compounds only initiate and attempt to facilitate an ion exchange that eventually forms and liberates an amount of lanthanum ions, such as, for example, ions from lanthanum chloride LaCl₃ as the eventual scavenger. The pool/spa operator must carefully administer the starting carbonate or oxide, most often in liquid form to the pool/spa water. Administering correct amounts is difficult, as is determining the need for repeat doses.

In addition, it has been reported that it is not desirable to admix amounts of lanthanum chloride directly into pool water as the resulting turbidity and cloudiness of the water is itself undesirable, and the fine suspension of the precipitated lanthanum phosphate is also undesirable, sometimes taking weeks to clear. Prior teachings warn of the inability to adequately filter out the lanthanum phosphate, resulting in a phosphate source for algae and leading to an increase in algal populations—the very problem being initially addressed. Other known systems have been suggested to avoid the complications derived from the direct addition of lanthanum chloride into the pool water for phosphate reduction (excessive turbidity, for example), including the use of various lanthanum carboxylates.

While it would be desirable to safely administer phosphate-removing compounds to pool/spa water in the context of a seasonal or other regular pool maintenance regimen, most desirably before an algal bloom occurs, such a convenient, pre-packaged dosing regimen and apparatus is not known.

In addition it would be advantageous and desirable to effect a control of both algae populations and pH control in a combined pool/spa treatment regimen designed for easy and safe handling by pool/spa owners.

### SUMMARY OF THE INVENTION

In one embodiment, the present invention relates to the introduction of rare earth metal or transition metal ions, preferably via their salts into pool/spa water for the purpose of regulating phosphate levels in the pool/spa water. Preferably, the salts are rare earth or transition metal halides and preferably, the salts are provided in solid form. Most preferably the salts are soluble and/or hygroscopic. The preferred compounds are sufficiently hygroscopic that they readily dissolve into the water.

In another embodiment of the present invention, the rare earth metal halide and transition metal halide salts are provided in solid form, and most preferably the salts are pre-loaded in a sealed cartridge application, or are released from a sealed package into a cartridge substantially immediately before introduction into the cartridge, most preferably for seasonal pool/spa use in an easy to handle fashion.

In a still further embodiment, the present invention relates to the observation that LaCl₃ alone, and preferably in the presence of zinc and/or copper metal ions and/or silver metal ions, provides a synergistic phosphate reducing effect to pool/spa water, resulting in a significant improvement over known algae control systems in pool/spa water.

In yet a still further embodiment of the present invention, the presence of LaCl₃ alone, or in the presence of zinc and/or copper metal ions and/or silver metal ions also provides a synergistic pH controlling effect coincidentally with the algal controlling/phosphate removal effect through the substantially sustained control and removal of phosphates from the water to a pre-determined level.

Therefore, Applicants' invention solves the problems associated with prior methods of pH control by the introduction of soluble rare earth metals or transition metal salts into pool/spa water. The rare earth and transition metal salts contemplated, according to embodiments of the present invention, are those capable of measurably affecting the pH of the water when added thereto. More particularly, according to embodiments of the present invention, the preferred rare earth and transition metal halides are those capable of measurably and predictably substantially affecting the pH of the water, or mitigating subsequent rises in the pH of the water, when added thereto, thus substantially eliminating or substantially reducing the need to add mineral acids to the water to control pH. Even more particularly, the rare earth and transition metal salts contemplated are those capable of reacting with hydroxide ions and/or carbonate ions to form a stable compound. Desirably, this stable compound is one that can be effectively removed from the pool water, but this is not necessary for the practice of the invention. Thus, embodiments of the present invention also relate to the use of rare earth and transition metal salts to control pH in water.

In a particular embodiment, Applicants' invention relates to the use of rare earth metal salts alone, or in combination with transition metals salts such as rare earth and transition metal halides, rare earth and transition metal borates, rare earth and transition metal sulfates, and the like, that are relatively and/or highly soluble in water, and that form transition metal hydroxides that are considerably less soluble in the water than the added transition metal salts. Particularly suitable transition metal salts include zinc halides, particularly zinc chloride, which, according to embodiments of this invention, are used to control the pH change (typically a rise) in water that accompanies chemical or electrolytic sanitation by introduction or production of hypochlorites. The preferred rare earth metal salts are lanthanide series compounds, with lanthanum and cerium being particularly preferred, with these compounds added in sufficient concentration to scavenge available phosphate from the water.

Methods of the present invention provide a technique for slowing, and in some cases, reversing, the rise in pH that occurs in such sanitation systems, without the need to use or handle potentially hazardous chemical species, including strong mineral acids, such as hydrochloric acid or sulfuric acid. Zinc chloride, in particular, is safe, easy to handle, readily dissolves in water, and forms a reaction product with hydroxyl ion and/or carbonate ion that is only very slightly soluble in water, enabling it to be removed from the water by filtration or other means, if desired. Meanwhile, according to embodiments of the present invention, the highly soluble lanthanide chlorides, most preferably lanthanum chloride is made easy and safe to handle by providing pre-dosed charges to the pool/spa's system by, for example, adding the charges to a pre-existing cartridge.

Still further, according to embodiments of the present invention, copper and/or silver is provided to the system in amounts that also behave synergistically with the transition metals (preferably zinc) and lanthanide metals (preferably lanthanum), the three components working together to help balance and maintain pH to a pre-determined level, while substantially simultaneously combining to control algae growth via depleting the available phosphate found in the water to pre-determined level, with efficiency and durations that equal or exceed the performance of the components separately.

More specifically, embodiments of this invention relate to a method for controlling pH in water, comprising adding to a stream or body of water, a transition metal salt, a lanthanide series salt in the presence or absence of copper and/or silver, in sufficient quantity to measurably and desirably effect the pH and algal concentration of the water through the reduction and/or substantial removal of available phosphate-containing compounds from the pool/spa water.

In another embodiment, the invention relates to a pH-controlling composition added to the water, and in particular, relates to a pH-controlling composition, comprising a pH-controlling amount of a transition metal halide and sufficient water to form an aqueous solution thereof, in the presence of an amount of a lanthanide series metal salt that may or may not be also in the presence of copper-containing or silver-containing compounds. Preferably, this composition desirably does not contain any hydrochloric acid, sulfuric acid, or other strong protic mineral acid, but is present in sufficient amounts to measurably affect the pH and phosphate levels of the water to which the composition is added.

### DETAILED DESCRIPTION OF THE INVENTION

According to embodiments of the present invention, the present invention relates both to the control of algal populations through the control and removal of algal phosphate nutrients from pool/spa water, while also regulating pool/spa water pH through the use of combinations of zinc-containing, copper-containing and/or silver-containing and lanthanide-containing compounds. More specifically, embodiments of the present invention relate to the use of zinc, copper and/or silver and lanthanum chloride for these purposes, provided together in synergistically optimum and effective amounts.

As described above, ions of transition metals such as those from transition metal salts, such as, for example, halides, borates, and sulfates can be used to control pH increases in pool or spa water that accompany sanitation of the water by “chlorination.” In particular, increases in pool water pH that typically accompany the operation of electrolytic chlorinators can be reduced and controlled by the addition of these transition metal halides. Particularly good results have been found with zinc halides, in particular, zinc chloride (ZnCl₂), but while the description herein focuses on this compound, it will be understood that the other transition metal halides can be used in substantially the same way to control pH in water. In addition to providing good pH control, zinc chloride is safe and easy to handle, measure, and add to pool water. Zinc chloride is highly water soluble, making its dispersal in pool water rapid and easy for the pool owner. Similarly, ions of transition metals can be obtained from solids made from transition metals, such as, for example, erosion of solids containing zinc and electrically driven zinc ionizers, etc.

Without wishing to be bound by any theory, it is believed that the transition metal salts used in embodiments of this invention form a reaction product with hydroxyl ion (e.g., zinc hydroxide) that is very slightly soluble in water, pulling hydroxyl ions out of the water where it would otherwise raise pH. In addition, because the hydroxide product is relatively insoluble, it can be removed from the pool water if necessary to, for example, drive the reaction to the right:

ZnCl₂+20H⁻ [symbol] Zn(OH)₂+2Cl⁻

In the discussion that follows, the term “pool” or “pool water” is intended not to be strictly limited to swimming pools, but to apply to any body of water whose pH must be controlled in response to a pH increase or pH change due to sanitation with a hypohalite. It is specifically intended to include water contained in spas, hot tubs, Jacuzzis, cooling towers, water purification installations, fountains, contained or semi-contained pond, and the like, etc.

The transition metal halide, e.g., zinc chloride, can be added to the pool water by any convenient technique. It has been found that the substantially continuous addition of fairly dilute aqueous solutions of zinc chloride provides better control of the pH time response than batch addition, although both are effective at controlling and slowing the rise in pH. The substantially continuous addition of aqueous zinc chloride solution via a reservoir and pump arrangement provides substantially continuous control, at appropriate concentrations of ZnCl₂. This method of addition can not only limit the increase in pH with time, but can actually reverse it, driving it back toward the pH level when operation of the chlorinator began. However, because zinc chloride is actually a Lewis acid, care should be taken that the amount added should not be so high as to drive the pH level below the starting point, unless such a result is desired.

In general, the amounts of transition metal halide added to the water may be substantially variable, depending upon, for example, water pool type, water conditions, chlorination levels, and method of addition, etc. According to one embodiment of the present invention, for bulk addition, amounts of solid zinc chloride ranging from about 10 mg to about 30 mg per gallon of water can be used. In this embodiment, for example, addition will need to be repeated preferably every 1-2 days or so, or when pH begins to rise again, depending upon chlorinator operation, pool chemistry, weather conditions, and the like, etc. Solid zinc chloride can be substantially continuously added, but use of an aqueous solution is more practical, as solid zinc chloride will absorb moisture from the surrounding air quite quickly. Aqueous solutions of concentrations preferably ranging from about 0.1 mM to about 1 M, more particularly, between about 10 mM and about 1 M can be advantageously used. Addition rates can be chosen so that, preferably, about 2.4 mg ZnCl₂/gal/hr is delivered to the water, in order to provide sufficient pH control for most conventional electrolytic chlorinators that typically deliver 1 mg Cl₂/gal/hr without causing cloudiness, or imparting an off-white color to the water. The volume of ZnCl₂ solution needed per gallon of water per hour preferably ranges from about 1.8 ml for a 10 mM ZnCl₂ solution to about 0.6 ml for a 30 mM ZnCl₂ solution. These molar concentrations of zinc chloride solution are suitable for the smaller volumes found, for example, in a spa or hot tub, etc. For a full sized swimming pool, a more concentrated ZnCl₂ may be appropriate. For a 1 M solution, the addition rate, preferably, would be about 0.18 L/hr, or about 1.4 L per 8 hour day. The use of a more concentrated solution reduces the volume of liquid that must be handled by the pool owner or technician, making use of the technique more practical. One of skill in the art can easily scale the addition rate based on these ranges and concentrations to a level suitable for any sized pool. If an electrolytic chlorinator is operated so as to release substantially more hydroxyl ions to the pool water (e.g., because the flow rate of chloride ion through the chlorinator is increased, or the chlorinator voltage is increased, or both), then a higher level of solution addition rate, or a more concentrated solution, may be required to maintain the proper pre-determined pH control.

The zinc chloride, whether added as a batch or substantially continuously, is added in the absence of hydrochloric acid, sulfuric acid, and/or other mineral acids. Moreover, pH control methods within the scope of the invention that includes the addition of zinc chloride for pH control, can be practiced without the addition of these acids to the pool water. In addition to avoiding the need to handle potentially hazardous chemicals conventionally used to control pH, the system according to embodiments of the invention lends itself to automated addition. For example, it is contemplated to be within the scope of the invention to add zinc chloride by controlled dispensing of an aqueous solution thereof, by a pumping mechanism, such as a diaphragm or peristaltic pump, or by another dispensing mechanism, such as, for example, a venturi inlet, etc.

This controlled dispensing mechanism can be connected electronically to a pH meter and a feedback controller so as to continuously control zinc chloride addition in response to changes in water pH. As the pH in the pool changes past a pre-determined set point, a pH meter senses this change and signals a controller to add more zinc chloride to the water when the deviation from the set point reaches a certain differential. When pH returns to the set point (i.e., within the differential from the set point) as measured by the pH meter, the controller discontinues zinc chloride addition.

Other transition metal halides that can be used in the invention include those capable of reacting with hydroxyl ions to form an insoluble or slightly soluble product. These include, for example, aluminum chloride (in particular, aluminum chloride hexahydrate), zinc bromide, zinc iodide, copper chloride (in particular copper chloride dihydrate), nickel chloride (in particular, nickel chloride hexahydrate), nickel bromide, nickel iodide, and tin halides, such as stannous chloride (anhydrous and dihydrate), stannous bromide, and stannous fluoride, etc.

### EXAMPLES

A DuoClear™ 15 electrolytic chlorinator sold by Zodiac Pool Care was suspended in a vessel containing 6 L of water and operated on an intermittent cycle on its lowest setting during the testing described below. The vessel was arranged so that zinc chloride could be added by either batch addition or through a peristaltic pump, and which was monitored for pH over time. The vessel was stirred with a magnetic stirrer. None of the examples involved the addition of hydrochloric acid or other mineral acids to the water, and temperature and other operating conditions were consistent from run to run. In the Comparative Examples below, conditions were the same as for the Examples, but zinc chloride was not added.

### Comparative Example 1

The operating conditions for Example 1 were followed except that no zinc chloride was added. Under two different trials, pH of the water increased from a beginning pH of 7.5 or 7.75 to a pH of approximately 9.1 after running the electrolytic chlorinator for only 60 minutes.

### Example 1

The apparatus was operated as described above. Prior to operation and zinc addition, the water was conditioned to simulate pool water by adding 1.2 g CaCl2 (to simulate water hardness) and 0.8 g NaHCO3 (to simulate water alkalinity), followed by addition of 10 g NaCl to provide the desired salinity for the electrolytic chlorinator. 6.28 g of zinc chloride was added by one-time batch addition and mixed overnight. Because the zinc chloride is a Lewis acid, this addition and mixing reduced the initial pH from 7.9 to 6.0. The resulting increase in pH was limited to approximately 1.25 pH units over 60 minutes, from an initial pH of around 5.75 to a final pH of around 7. This is approximately half of the pH increase occurring in the control experiments.

### Example 2

The procedure described in Example 1 was followed, except that following water conditioning, zinc chloride was added as a 12.2 mM aqueous solution via a peristaltic pump at a rate of 10.5 ml/min. The pH of the system shows a net increase of only about 0.8 pH units over 60 minutes of operation. Perhaps more significantly, after about 10 minutes of operation, the pH time response curve is essentially flat, with only a slight upward trend occurring at about 60 minutes. This is in contrast to both the control and the batch addition curves which, while seeming to increase more slowly after 60 minutes, still show a more decided upward trend. EXAMPLE 3

The procedure described in Example 2 was followed, except that the zinc chloride was added as a 25 mM solution at a rate of 10.2 ml/min. Over the course of 60 minutes of operation, the pH increase was only about 0.2 pH units. Moreover, after about 30 minutes of operation, the pH time response curve was trending downward, indicating that the zinc chloride addition was not only preventing further pH increase, but was actually beginning to reverse the increase and return pH toward the pH level when the chlorinator operation began.

### Example 4

The electrolytic chlorination and ZnCl₂ addition procedure was scaled up to a 200 gallon “mini-pool” using the apparatus having a filter, recirculation pump, ZnCl₂ metering pump and flask containing the ZnCl₂ solution, chlorine cell and controller, and plumbing system, were all in fluid communication with the pool, which could also be applied to a full sized pool with appropriate changes in equipment. In this system, zinc chloride is supplied as a 25 mM aqueous from reservoir to the mini-pool. The solution is forced by peristaltic pump through electrolytic chlorinator (which is controlled by controller. Water in mini-pool is recirculated through filter by centrifugal pump (2 hp). A portion (or all) of the recirculated water may be returned to mini-pool by bypass line, while another portion is conducted by line through flow meter to electrolytic chlorinator. Those of skill in the art will recognize that the same or similar arrangement of apparatus could be used to purify water and control pH in much larger pools, optionally using larger capacity equipment.

Three experiments were conducted, monitoring pH, temperature, and free available chlorine. All were conducted in simulated pool water, balanced with respect to pH, total alkalinity, hardness and cyanuric acid chlorine stabilizer. Pumping flowrate was roughly 80 gpm. The first experiment was a “system control”, monitoring pH and temperature without chlorination or addition of ZnCl₂. The second experiment was a “Cl₂ control”, where only chlorine was added at a rate of 2 g/hr. The third experiment (“ZnCl₂+Cl₂”) involved chlorination at the same rate as experiment 2 plus the continuous, in-line metered addition of a 25 mM solution of ZnCl2 at a rate of 1.2 liters/hr, which was a 5% stoichiometric excess. The temperature-corrected pH was monitored in-line with readings taken at regular intervals. The water temperature increase of 4.5° C. was consistent for all three experiments. The system control pH increased by 0.2 pH units over a period of 170 minutes, which is believed to be the result of CO₂ loss from the water. A 0.5 pH unit increase was experienced in the Chlorine control experiment over a period of 155 min. Finally, the ZnCl₂ metering experiment resulted in no pH increase over the course of 125 minutes during which the ZnCl₂ metering pump was operating. After 125 minutes of elapsed time, the ZnCl₂ pump was turned off while the pH continued to be monitored. The pH dropped 0.02 units followed by an increase of 0.35 units over a 200 minute period as the excess ZnCl₂ was consumed and an excess of hydroxyl ion was generated by the chlorinator.

The Examples described above show that transition metal halides, such as zinc chloride, can be effectively used to control the change (typically an increase) in pH resulting from the use of chlorination, in particular electrolytic chlorination, to sanitize pools. This use does not require the handling of dangerous protic acids, does not cause corrosion of ancillary pipes or other equipment, lends itself to automation, and requires little care and maintenance.

According to embodiments of the present invention, it has now been further discovered that, by adding amounts of lanthanide-containing compounds, preferably lanthanum chloride in the presence of zinc and copper and/or silver, significant synergistic effects result, not only improving pH control, but also in reducing and substantially removing phosphate from pool/spa water, thus controlling algal populations in pool/spa water. This synergistic effect is unexpected, and results in the ability to potentially reduce the amount of zinc and copper used in the water treatment products currently available.

In addition, the presence of zinc with copper and/or silver, along with the lanthanide compounds, appears to increase the potential for algae control as compared to the use of lanthanides alone. Further, according to embodiments of the present invention, the presence of the multiple compounds together, in predetermined amounts, serves to beneficially treat bodies of water, such as, for example, pools and spas (both fresh and salt water varieties) for multiple conditions, such as, for example, pH control and algae growth control.

In one embodiment, the lanthanide compound is a salt of any lanthanide. Lanthanides are recognized as comprising lanthanum, cerium, praseodymium, neodymium, promethium, samarium, europium, gadolinium, terbium, dysprosium, holmium, erbium, thulium, ytterbium and lutetium. However, since these elements are relatively expensive, lanthanum and cerium presently appear to be the most practical selections.

The most preferred lanthanide salts to be incorporated into the water treatment regimens, according to embodiments of the present invention, are lanthanide chlorides and cerium chlorides. In one preferred embodiment, the lanthanide salts will be provided to an existing cartridge-type system in-line, in the pool/spa water circulation system. Such a system (“Clearwater®”) is available from Jandy Pool Products/Zodiac Pool Care, (Moorpark, Calif.) and presently sold under the Nature2® brand name. Preferably, the lanthanide salt, most preferably, lanthanum chloride or cerium chloride will be provided in solid, granular or powdered form. Since the lanthanide chlorides are hygroscopic, it is contemplated that the lanthanide salt would be provided to the consumer in a sealed, single-use mode, since, any other mode would risk having the lanthanide decompose, as it readily absorbs moisture. While the solid form is preferred, embodiments of the present invention contemplates administering the lanthanide directly to the pool as either a solid, liquid, gel suspension, etc., within or outside of the cartridge.

While known methods and products of algal control have contemplated some forms of lanthanide-containing compounds, chloride forms have been discarded as unworkable in favor of carbonates or others. Conventional practice in the use of lanthanum compounds for algal control, requires lanthanum forms that dissolve slowly and that produce no or low amounts of visible precipitate in the pool. By contrast, embodiments of the present invention welcome the properties of the fast-dissolving, preferred lanthanum chloride or cerium chloride, regardless of the bound phosphate precipitate. While not wishing to be bound to any one theory, it is believed that the fast administration of the lanthanide compound, primarily for algae control through significant and substantial phosphate elimination, provides a beneficial environment for the synergistic effects of the released zinc and/or copper, to both assist in algae control while substantially simultaneously working together to control desired pH ranges.

While it is theoretically possible to remove virtually all phosphate from a pool/spa, constant usage or exposure to organic matter such as leaves and other biological material makes at least some phosphate presence in the water a reality. Therefore, for the purpose of this application, effective or substantial phosphate removal means a phosphate level below about 200 ppb (the accepted phosphate level at which phosphate are believed to act as nutrients for an algal population), although embodiments of the present application contemplate applying the lanthanide, copper and/or silver and zinc in selected, predetermined amounts that will deliver predetermined and desired effect to both the pH value and the phosphate level.

It is further understood that the precipitated or complexed phosphates may be removed by ordinary filtration over an acceptable period of time with adequate filtration system throughput. Additional flocculants or sequestrants, as would be readily understood by those in the pool/spa chemical field, may be added to further assist in phosphate precipitation and aid in collection or filtration by separate collection means, such as for example, suction or other physical removal. Backwashing of the pool/spa filtration unit may be required if water cloudiness persists. It is contemplated that the pool/spa water should be clear in from about 24 to about 48 hours. In this way, one application of the products and methods of preferred embodiments of the present invention are conducive to “opening” a pool for the season, where such a delay for water conditioning of up to two days would be expected and would not be viewed as an inconvenience. In other embodiments of the invention, it is contemplated that, through the use of the synergistic effects of the zinc, copper and/or silver and lanthanide, or just the zinc and lanthanide, that the time for water treatment for phosphate and pH balance could be achieved in significantly less time than 24 hours.

Again, while it is believed that the orthophosphate is most reactive with the lanthanide, the synergistic combination of the lanthanide/copper and/or silver/zinc may be acting to remove precursor phosphates in addition to the orthophosphates.

According to embodiments of the present invention, pool/spa maintenance for pH and algae treatment is greatly simplified, as the pool/spa owner merely needs to charge his existing filtration cartridge with a pre-dosed pack of lanthanide salt complex, or install a cartridge already preloaded with the lanthanide salt preferably in addition to the copper and/or silver and zinc sources also loaded in the cartridge or provided to the system separately from the cartridge. As mentioned above, the products and processes of the present invention are useful with both fresh and salt water pools/spas.

As stated above, the highly hygroscopic lanthanide compound selected, would be packaged in a sealed pouch for placement into a cartridge or for deposit directly in the pool/spa. Alternatively, the lanthanide could be packaged in a sealed cartridge to assure the contents against exposure to moisture before use. The sealed package may be any useful plastic, starch or other material, and may be biodegradable, for example, if the pouch is to be deposited directly into the pool/spa.

Again, as stated above, it is to be understood that the direct use of the preferred lanthanides such as, for example, lanthanum chloride and cerium chloride, when brought into contact with pool/spa water having phosphates present, will “cloud” the water. However, this is a desirable result, as the pool/spa owner (for example at the beginning of a season upon “opening” a pool) will be able to identify the presence of phosphates by the action of the lanthanum chloride and other contents of the added chemical packet or cartridge. Similarly, the owner will know when the phosphates have been substantially removed from the pool/spa to an acceptable level (below about 200 ppb), as the pool/spa water will return to a very clear state.

With regard to the now discovered synergy among the combined use of lanthanides and zinc, observed results allow us to conclude that zinc, alone or in combination with the lanthanide, exhibits an ability to act either as an algicide directly, or complexes with the phosphates in a way to reduce their availability as a nutrient for algae. Similarly, transition metals, such as, for example copper and silver have been known and have been used as an algicide/algistat. Though we do not wish to be bound by any particular theory, it is not believed that copper or silver insolubly complex with phosphate at the copper and silver concentrations practiced according to embodiments of the present invention, as analyses have not indicated the presence of any copper and/or silver phosphate complexes. Therefore, if an algal population decreases or ceases to grow in the presence of copper and or silver, it is believed that copper and/or silver is acting on the algae directly and not the phosphates.

According to some embodiments of the present invention, combining copper ions and/or silver ions with lanthanide ions from lanthanide compounds, preferably lanthanum chloride and cerium chloride, has been observed to improve the role of copper and silver as an algicide/algistat; beyond their expected performance. In other words, early data has been obtained that suggests that the use of lanthanide compounds (to reduce the phosphate levels) in combination with copper and/or silver, seems to increase the performance of copper and/or silver as an algicide/algistat.

Further, according to embodiments of the present invention, it is understood that copper and silver represent transition metals particularly useful as algicides, and that these metals are to be provided, to a water environment to be treated, in efficacious and pre-selected amounts, and exist in solution in ion form. Such metal ions are provided to the water environment, preferably contained and recirculated environments, such as, for example, pools and/or spas, etc. from metal any useful metal ion sources such as, for example, metals and metal salts.

According to further embodiments, the various components (La, Zn, and/or Cu and/or Ag) may be added to the water directly. More preferably, the components will be added via use of a cartridge in line with the circulated water. It is to be understood that the components may be added to one cartridge or be dispensed from various cartridges as desired. In other words, for example, the silver source may be provided to a discrete cartridge, while the lanthanum source, and zinc and/or copper and/or silver sources are in another cartridge. Various other combinations may be used as desired. In one particularly preferred embodiment, at least the silver is sourced to the system via activated porous spherized alumina that has been impregnated with silver nitrate, although any silver source that produces silver ions to the water is acceptable, such as, for example, silver metal or silver salt.

While the present invention has been described in detail with reference to specific embodiments thereof, it will be apparent to one skilled in the field that various changes, modifications and substitutions can be made, and equivalents employed without departing from, and are intended to be included within, the scope of the claims.

What is claimed is:

1. A method for reducing algal populations in a body of water comprising the steps of:
providing to the body of water an amount of lanthanide salt in a quantity sufficient to reduce phosphate concentrations in the body of water to a concentration of from about 200 ppb to about 2500 ppb.

2. The method of claim 1, further comprising the step of:
providing an amount of copper in sufficient quantity along with the lanthanide salt to reduce the phosphate concentration in the body of water to a concentration of from about 200 ppb to about 2500 ppb.

3. The method of claim 1, further comprising the step of:
providing an amount of silver in sufficient quantity along with the lanthanide salt to reduce the phosphate concentration in the body of water to a concentration of from about 200 ppb to about 2500 ppb.

4. The method of claim 3, further comprising the step of:
providing an amount of copper along with the silver in sufficient quantity along with the lanthanide salt to reduce the phosphate concentration in the body of water to a concentration of from about 200 ppb to about 2500 ppb.

5 The method of claim 1, wherein the lanthanide is selected from the group consisting of: lanthanum chloride and cerium chloride.

6. The method of claim 1, further comprising the step of:
providing an amount of a transition metal to the body of water with an amount of lanthanide salt in a quantity sufficient to reduce phosphate concentrations in the body of water to a concentration of from about 200 ppb to about 2500 ppb.

7. The method of claim 1, further comprising the step of:
providing an amount of a metal selected from the group consisting of copper and silver to the water, and providing an amount of a transition metal to the body of water with an amount of lanthanide salt in a quantity sufficient to reduce phosphate concentrations in the body of water to a concentration of from about 200 ppb to about 2500 ppb.

8. The method of claim 6, wherein the pH of the body of water is maintained in a predetermined range.

9. The method of claim 7, wherein the pH of the body of water is maintained in a predetermined range.

10. The method of claim 1, wherein the transition metal is added as a salt, said salt being selected from the group consisting of: a transition metal halide, borate, sulfate and nitrate.

11. The method of claim 6, wherein the transition metal is zinc (II).

12. The method of claim 10, wherein the transition metal salt is a zinc (II) halide.

13. The method of claim 10, wherein the transition metal halide is zinc (II) chloride.

14. The method of claim 6, wherein at least one of the lanthanide, and transition metal is added in a mode selected from the group consisting of: a batch addition mode, a substantially continuous mode, and combinations thereof.

15. The method of claim 7, wherein at least one of the lanthanide, copper and transition metal is added in a mode selected from the group consisting of: a batch addition mode, a substantially continuous mode and combinations thereof.

16. The method of claim 11, wherein the transition metal salt comprises an aqueous solution of zinc (II) chloride.

17. The method of claim 11, wherein the aqueous solution has a concentration of between about 0.1 mM and about 1 M.

18. The method of claim 10, wherein the transition metal salt is added in the absence of pH modifying amounts of hydrochloric acid.

19. The method of claim 10, wherein the transition metal salt is added in the absence of pH modifying amounts of any mineral acid.

20. The method of claim 6, further comprising:
sensing the pH of the water;
comparing the sensed pH to a set point, thereby generating a pH differential;
introducing an amount of transition metal to the water when the pH differential reaches a predetermined value;
wherein the amount of transition metal is sufficient to reduce the pH differential.

21. The method of claim 7, further comprising:
sensing the pH of the water;
comparing the sensed pH to a set point, thereby generating a pH differential;
introducing an amount of transition metal to the water when the pH differential reaches a predetermined value;
wherein the amount of transition metal is sufficient to reduce the pH differential.

22. A composition for reducing algal populations in a body of water comprising:
an amount of a metal selected from the group consisting of copper and/or silver to the water, and an amount of a transition metal to the body of water with an amount of lanthanide salt in a quantity sufficient to reduce phosphate concentrations in the body of water to a concentration of from about 200 ppb to about 2500 ppb.

23. The composition of claim 22, wherein the pH of the body of water is maintained in a predetermined range.

24. The composition of claim 22, wherein the transition metal is in a salt form, said salt being selected from the group consisting of: a transition metal halide, borate, sulfate and nitrate.

25. The composition of claim 22, wherein the transition metal is zinc (II).

26. The composition of claim 25, wherein the transition metal salt is a zinc (II) halide.

27. The composition of claim 26, wherein the transition metal halide is zinc (II) chloride.

28. The composition of claim 22, wherein at least one of the lanthanide, and transition metal is added in a mode selected from the group consisting of: a batch addition mode, a substantially continuous mode, and combinations thereof.

29. The composition of claim 22, wherein at least one of the lanthanide, copper and transition metal is added in a mode selected from the group consisting of: a batch addition mode, a substantially continuous mode, and combinations thereof.

30. The composition of claim 24, wherein the transition metal salt comprises an aqueous solution of zinc (II) chloride.

31. The composition of claim 30, wherein the aqueous solution has a concentration of between about 0.1 mM and about 1 M.

32. The composition of claim 24, wherein the transition metal salt is added in the absence of pH modifying amounts of hydrochloric acid.

33. The composition of claim 24, wherein the transition metal salt is added in the absence of pH modifying amounts of any mineral acid.

34. A body of water comprising the composition of claim 22.
